(19) United States
(12) Patent Application Publication
(10) Pub. No.: US 2024/0231837 A1
(43) Pub. Date: Jul. 11, 2024

(54) METHODS AND APPARATUS TO INTEGRATE SMARTNICS INTO PLATFORM MANAGEMENT SYSTEMS

(71) Applicant: VMware LLC, Palo Alto, CA (US)

(72) Inventors: Marcus Armando Benedetto Campi, Palo Alto, CA (US); Anjaneya Prasad Gondi, Palo Alto, CA (US)

(21) Appl. No.: 18/152,686

(22) Filed: Jan. 10, 2023

(51) Int. Cl. G06F 9/4401

(52) U.S. Cl. CPC G06F 9/4416

(57) ABSTRACT

Methods, apparatus, systems, and articles of manufacture are disclosed to integrate smartNICs into platform management systems. A disclosed example includes determining a presence of a smart network interface card based on detection of a kernel-to-kernel network interface card; classifying a request from a client application, the request to obtain sensor data; determining whether the request is to be sent to a server hardware baseboard management controller or the smart network interface card; based on the determination, causing sending of the request to the smart network interface card, the request to cause the smart network interface card to obtain the sensor data from a sensor corresponding to the smart network interface card; and accessing a response from the smart network interface card, the response indicative of at least one sensor data record corresponding to the sensor.

### FIELD OF THE DISCLOSURE

This disclosure relates generally to network-based computing, and, more particularly, to integrating smart network interface cards into platform management systems.

### BACKGROUND

Hypervisors can be used to create and manage virtual machines (VMs) by virtualizing hardware and can be used to consolidate applications and cut costs. Hypervisors allow running one or more virtual machines on underlying hardware independent of specific knowledge about the underlying hardware. Such virtual machines can then be used to run corresponding operating systems such that multiple operating systems in respective virtual machines can run concurrently on a hypervisor while sharing the underlying hardware resources. To control and monitor remote computers, an Intelligent Platform Management Interface (IPMI) provides an interface for platform management.

### BRIEF DESCRIPTION OF THE DRAWINGS

FIG. 1 is an illustration of an example environment including a server rack.

FIG. 2 is an illustration of an example environment in which an example intelligent platform management interface (IPMI) may be implemented.

FIG. 3 is a block diagram of example IPMI device driver circuitry.

FIG. 4 is a block diagram of example IPMI smart network interface card (smartNIC) proxy circuitry.

FIG. 5 is a flowchart representative of example machine readable instructions and/or example operations that may be executed to implement the example IPMI device driver circuitry of FIG. 2 to forward IPMI requests to a server hardware Baseboard Management Controller (BMC) and/or a smartNIC BMC.

FIG. 6 is a flowchart representative of example machine readable instructions and/or example operations that may be executed to implement the example IPMI device driver circuitry of FIG. 2 to access and handle a global IPMI request.

FIG. 7 is a flowchart representative of example machine readable instructions and/or example operations that may be executed to implement the example IPMI device driver circuitry of FIG. 2 to access and handle a specific IPMI request.

FIG. 8 is an example table representative of information associated with a get sensor data record (SDR) request to obtain SDR information.

FIG. 9 is an example table representative of a resource map which may be referenced by the example IPMI device driver circuitry of FIG. 2.

FIG. 10 is a block diagram of an example processing platform including processor circuitry structured to execute the example machine readable instructions and/or the example operations of FIGS. 5, 6, and 7 to implement the example IPMI device driver circuitry of FIG. 2.

FIG. 11 is a block diagram of an example implementation of the processor circuitry of FIG. 10.

FIG. 12 is a block diagram of another example implementation of the processor circuitry of FIG. 11.

FIG. 13 is a block diagram of an example software distribution platform (e.g., one or more servers) to distribute software (e.g., software corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

IPMI (Intelligent Platform Management Interface) provides standard specifications for platform management. IPMI provides a standard way to perform platform management operations such as power management, sensor monitoring and system image configuration, with both in-band and out-of-band management options available. IPMI has been sufficient for previous platform management needs, largely because hardware architectures have remained relatively unchanged. Examples disclosed herein enable improved functionality to manage hardware architectures based on smartNICs (smart network interface cards). In examples disclosed herein, smartNICs are highly programmable and configurable network interface cards. For example, smartNICs are able to improve networking, storage, and security functions by serving as a data processing unit. In some examples, smartNICs include their own CPU complexes and their own IPMI subsystem, both of which are disjointed from the hardware in which they operate. From a software perspective, smartNICs can be configured to run their own operating system. For example, ESXI™, a VMware bare metal hypervisor platform, has been ported to run on Arm smartNICs, which is called ESXio™. In some examples, smartNICs disclosed herein may be implemented as ARM-based smartNICs that run an ARM-specific hypervisor platform called ESXio™. For example, ESXio™ can be based on the ESXi™ VMware bare metal hypervisor platform. Creating a unified platform management system that integrates a smartNIC IPMI into traditional platform management presents challenges.

Typically, an example IPMI configuration has a single Baseboard Management Controller (BMC) chip directly hardwired to CPUs, sensors, and devices that the IPMI system manages. In this manner, a BMC can read and report sensor information from sensors. An example operating system exposes access to this BMC via an IPMI character device driver. For example, this IPMI character device driver may be at path/dev/ipmi. There is a large array of legacy software that uses this character device, including tools such as ipmitool, freeipmi, ipmiutil, esxcli, etc., and the hardware health monitoring screen that is seen, for example, in VSPHERE® client software from VMware, Inc. This channel of communication goes through the operating system and is known as in-band platform management. A BMC typically runs its own operating system, and contains a dedicated NIC and power source that is separate from the server it manages. This allows the BMC to perform its duty regardless of the state of the server in which it operates, giving it the ability to start the system and query it when the operating system is down. This is known as out-of-band management, because the main server operating system is not used to manage the platform. This system is effective for managing items hardwired onto the server's mainboard, but it presents challenges for pluggable devices such as peripheral component interconnect (PCI) devices such as smartNIC devices.

To integrate outside devices into the IPMI model, interoperability is preserved with existing applications, like ipmitool. Ipmitool is one example of an application which provides a command-line interface to a user. Disclosed apparatus, methods, systems, and articles of manufacture incorporate a solution to integrate smartNICs into an example system IPMI by modifying the IPMI device driver to provide access to the smartNIC's IPMI system. Disclosed apparatus, methods, systems, and articles of manufacture include a kernel-to-kernel network interface card (NIC) for communication between the server and smartNICs. For example, a NIC may facilitate communication between a VMkernel (e.g., a virtualization interface between a virtual machine and a hypervisor running on a host server) and a smartNIC. The IPMI device driver can be modified to detect if this communication channel NIC is present, and hence a smartNIC is on the system. The IPMI device driver can then use this NIC to query the smartNIC for IPMI details such as processor temperature, RPM, power-supply voltage, humidity, and/or other communications parameters and/or operating system functions, etc. The sensor data collected from the IPMI device driver can be modified as needed. The IPMI standard includes specifications on how data can be formatted for satellite processors, and the IPMI device driver can convert this data into this format.

Virtualizing computer systems provides benefits such as the ability to execute multiple computer systems on a single hardware computer, replicating computer systems, moving computer systems among multiple hardware computers, and so forth. Virtualized computer systems may be used to implement cloud computing platforms that give an application developer access to infrastructure resources, such as virtualized servers, storage, and networking resources. By providing ready access to the hardware resources required to run an application, a cloud computing platform enables developers to build, deploy, and manage the lifecycle of a networked application. Cloud computing environments may be composed of many processing units (e.g., servers). The processing units may be installed in standardized frames, known as racks, which provide efficient use of floor space by allowing the processing units to be stacked vertically. The racks may additionally include other components of a cloud computing environment such as storage devices, networking devices (e.g., switches), etc.

Examples disclosed herein may be used with one or more different types of virtualization environments. Three example types of virtualization environment are: full virtualization, paravirtualization, and operating system virtualization. Full virtualization, as used herein, is a virtualization environment in which hardware resources are managed by a hypervisor to provide virtual hardware resources to a virtual machine. In a full virtualization environment, the virtual machines do not have access to the underlying hardware resources. In a typical full virtualization, a host operating system with embedded hypervisor (e.g., a VMware ESXi® hypervisor) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical random access memory (RAM) with virtual RAM). Typically, in full virtualization, the virtual machine and the guest operating system have no visibility and/or access to the hardware resources of the underlying server. Additionally, in full virtualization, a full guest operating system is typically installed in the virtual machine while a host operating system is installed on the server hardware. Example virtualization environments include VMware ESX® hypervisor, Microsoft Hyper-V® hypervisor, and Kernel Based Virtual Machine (KVM).

Paravirtualization, as used herein, is a virtualization environment in which hardware resources are managed by a hypervisor to provide virtual hardware resources to a virtual machine, and guest operating systems are also allowed to access some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

Operating system virtualization is also referred to herein as container virtualization. As used herein, operating system virtualization refers to a system in which processes are isolated in an operating system. In a typical operating system virtualization system, a host operating system is installed on the server hardware. Alternatively, the host operating system may be installed in a virtual machine of a full virtualization environment or a paravirtualization environment. The host operating system of an operating system virtualization system is configured (e.g., utilizing a customized kernel) to provide isolation and resource management for processes that execute within the host operating system (e.g., applications that execute on the host operating system). The isolation of the processes is known as a container. Thus, a process executes within a container that isolates the process from other processes executing on the host operating system. Thus, operating system virtualization provides isolation and resource management capabilities without the resource overhead utilized by a full virtualization environment or a paravirtualization environment. Example operating system virtualization environments include Linux Containers LXC and LXD, the Docker™ container platform, the OpenVZ™ container platform, etc.

In some examples, a data center (or pool of linked data centers) may include multiple different virtualization environments. For example, a data center may include hardware resources that are managed by a full virtualization environment, a paravirtualization environment, and an operating system virtualization environment. In such a data center, a workload may be deployed to any of the virtualization environments. Through techniques to monitor both physical and virtual infrastructure, examples disclosed herein provide visibility into the virtual infrastructure (e.g., virtual machines (VMs), virtual storage, virtual networks and their control/management counterparts) and the physical infrastructure (servers, physical storage, network switches).

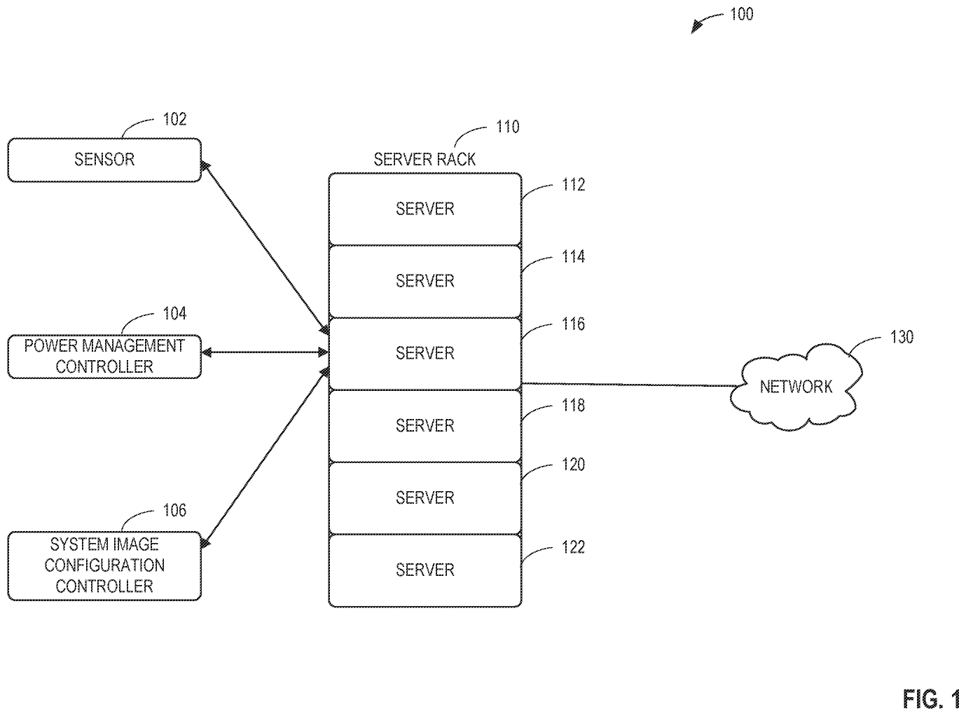

FIG. 1 is an illustration of an example environment 100 including a server rack 110. The example environment 100 of FIG. 1 includes an example sensor 102, an example power management controller 104, an example system image configuration controller 106, and the example server rack 110. The example server rack 110 includes servers 112, 114, 116, 118, 120, and 122, and is connected to an example network 130. The example sensor 102 of FIG. 1 is responsible for sensing measurements and data, including temperature, electrical current draw, power consumption, power state (e.g., on, off, standby, hibernate, etc.) etc. The example power management controller 104 is responsible for managing the power state of any number of servers of the server rack 110, including determining when any one of the example servers 112, 114, 116, 118, 120, and/or 122 is to be powered on, powered off, or in some other power state. The example power management controller 104 may also be responsible for maintaining rules regarding the power management of any of the example servers 112, 114, 116, 118, 120, and/or 122, and, more generally, the server rack 110. The example system image configuration controller 106 may be responsible for controlling configuration of an example system image. For example, the example system image configuration controller 106 may be responsible for generating process images to provide system persistence. The example server rack 110 of the illustrated example enables abstracting hardware resources (e.g., physical resources). In some examples, the server rack 110 includes one or more physical racks, with each rack including hardware such as server nodes (e.g., compute+storage+network links), network switches, and, optionally, separate storage units. From a user perspective, the example server rack 110 is an aggregated pool of logic resources exposed as one or more VMWARE® ESXI™ clusters along with a logical storage pool and network connectivity. In examples disclosed herein, a cluster is a server group in a virtual environment. For example, a VMWARE® ESXI™ hypervisor cluster is a group of physical servers in the physical hardware resources that run ESXI™ hypervisors to virtualize processor, memory, storage, and network resources into logical resources to run multiple VMs that run operating systems (OSs) and applications as if those OSs and applications were running on physical hardware without an intermediate virtualization layer. The example servers 112, 114, 116, 118, 120, and/or 122 are included in the server rack 110, but the server rack 110 may include any number of servers and/or other resources to, for example, virtualize physical hardware resources into virtual resources. The example network 130 may facilitate exchange of data with external machines (e.g., computing devices of any kind). The connection can be by, for example, an Ethernet connection, a digital subscriber line (DSL) connection, a telephone line connection, a coaxial cable system, a satellite system, a line-of-site wireless system, a cellular telephone system, an optical connection, etc. The example network 130 may interface with communication devices including one or more transmitters, receivers, transceivers, modems, residential gateways, wireless access points, and/or network interfaces to facilitate the exchange of data.

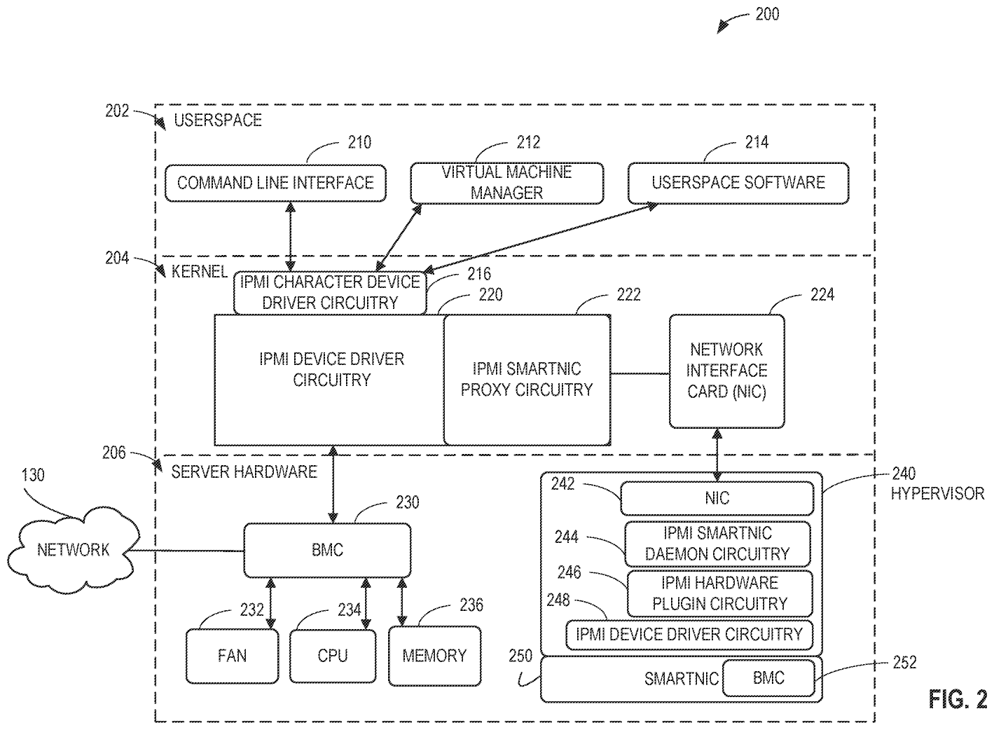

FIG. 2 is a schematic illustration of an example computer virtualization system 200 including an IPMI configuration. The example computer virtualization system 200 includes an example userspace 202, an example kernel 204, and example server hardware 206. In example FIG. 2, the example server hardware 206 may be implemented by one or more servers 112, 114, 116, 118, 120, 122 of the server rack 110 of FIG. 1. The example userspace 202 includes an example command line interface 210, an example virtual machine manager 212, and example userspace software 214. The example kernel 204 includes example IPMI character device driver circuitry 216, example IPMI device driver circuitry 220, example IPMI smartNIC proxy circuitry 222, and an example network interface card (NIC) 224. The example server hardware 206 includes a first example BMC 230 (e.g., a server hardware BMC 230), an example fan 232, an example CPU 234, an example memory 236, an example hypervisor 240, and an example smartNIC 250. The example hypervisor 240 includes an example NIC 242, example IPMI smartNIC daemon circuitry 244, example IPMI hardware plugin circuitry 246, and example IPMI device driver circuitry 248. The example smartNIC 250 includes an example smartNIC BMC 252. The example server hardware BMC 230 is connected to an example network 130.

In the example userspace 202 of FIG. 2, the example command line interface 210 is provided to receive commands from user entries in the form of text. The example userspace 202 is provided with the example virtual machine manager 212 to receive commands involving virtual machine management. The example userspace 202 is provided with the userspace software 214 to receive and/or provide user commands. Example user commands include commands related to IPMI requests to identify sensor data corresponding to one or more sensors of a system. In some examples, the example command line interface 210 may be implemented by ipmitool, which provides a command-line interface to IPMI-enabled devices through a local area network (LAN) interface or kernel driver.

The example kernel 204 may be implemented using a VMkernel which is a virtualization interface between a virtual machine and a hypervisor (e.g., the hypervisor 240) running on a host server (e.g., the server hardware 206). The example kernel 204 is provided with the example IPMI character device driver circuitry 216 to facilitate communication between the example IPMI device driver circuitry 220 and the userspace 202. In example FIG. 2, the IPMI character device driver circuitry 216 receives or accesses commands from the userspace 202 (e.g., from one or more of the example command line interface 210, the example virtual machine manager 212, and/or the userspace software 214). After accessing a command, the example IPMI character device driver circuitry 216 forwards a request, including the command, for handling by the IPMI device driver circuitry 220. In some examples, the IPMI character device driver circuitry 216 is at/dev/ipmi, which is a module in the kernel 204 which facilitates communication between the example userspace 202 and the example kernel 204. In turn, the example IPMI device driver circuitry 220 receives the request from the IPMI character device driver circuitry 216. In some examples, the request received by the IPMI device driver circuitry 220 may be a GET SENSOR REPO INFO request. This request may be used to query a system (e.g., the server hardware 206) to determine a quantity of sensors available in the system and/or the type(s) of sensors available in the system. These sensors may also be responsible for returning sensor data, including RPM data, temperature data, and/or other system data, etc.

In example FIG. 2, the IPMI device driver circuitry 220 communicates with the server hardware BMC 230 of the server hardware 206 to obtain server hardware IPMI sensor data corresponding to sensors of the server hardware 206. Such sensors monitor aspects of, for example, the fan 232, the CPU 234, and the memory 236 of the server hardware 206. In some examples in which smartNICs have less sophisticated hardware (e.g., a smartNIC that does not include a BMC), a vendor can provide custom software that reads and reports sensor information. For example, in such cases sensor monitoring can be performed by the vendor-provided custom software reading sensors through I2C buses. For example, a Linux application may use lm-sensors (e.g., Linux monitoring sensors to monitor temperatures, voltages, fans, etc.) which may return an example output:

~$ sensors
k8temp-pci-00c3
Adapter: PCI adapter
Core0 Temp: +30.0°C
Core0 Temp: +30.0°C
Core1 Temp: +29.0°C
Core1 Temp: +36.0°C

This example output includes a list of example CPU temperature sensors, and this data is one example of data that may be handled by the example IPMI smartNIC daemon circuitry 244. This example output indicates a sensor count of four and temperature data from each sensor.

In addition, the example IPMI smartNIC proxy circuitry 222 communicates with the hypervisor 240 of the server hardware 206 via a kernel-to-kernel NIC formed by the NIC 224 of the kernel 204 and the NIC 242 of the hypervisor 240 in the server hardware 206. In some examples, the kernel-to-kernel NIC is referred to as a special kernel-to-kernel vmnic. For example, it may be referred to as “special” because unlike typical uses of NICs to connect a machine to a network, a kernel-to-kernel NIC is for internal connectivity between the kernel 204 and the server hardware 206. In addition, vmnic can be used to refer to a virtual object that is instantiated in a hypervisor (e.g., the hypervisor 240) and linked to a physical NIC (pNIC). In this manner, a vmnic is used to provide network communications between virtual resources and a physical switch via a pNIC. In example FIG. 2, the NIC 224 and the NIC 242 represent network interfaces formed by vmnics and one or more corresponding pNICs.

In the illustrated example of FIG. 2, the example server hardware BMC 230 may be connected to a network 130 to facilitate receiving and sending of instructions and/or other communications between the server hardware BMC 230 and the network 130. In the illustrated example of FIG. 2, the example smartNIC BMC 252 runs on the smartNIC 250 and is not accessed directly by the example hypervisor 240. In some examples, the IPMI smartNIC daemon circuitry 244 is responsible for receiving and/or transmitting requests to the hypervisor 240. In some examples, the IPMI hardware plugin circuitry 246 handles a request by sending the request to the IPMI device driver circuitry 248 or to another hardware package, which may return a response (e.g., a response including sensor data) to be forwarded to the IPMI smartNIC proxy circuitry 222. In some examples, the IPMI hardware plugin circuitry 246 is employed as a hardware-specific plugin because the actual underlying hardware (e.g., CPUs, fans, memory, etc.) differs between multiple smartNICs that may be installed in a system.

In example FIG. 2, the example IPMI device driver circuitry 220 forwards a request to the server hardware BMC 230 to obtain server hardware IPMI sensor data (e.g., server hardware IPMI sensor information). The request may be a GET SENSOR REPO INFO request to request data regarding a quantity and/or type(s) of sensors in a system. In some examples, the server hardware BMC 230 may return a response indicative of hardware and/or other sensors on the system, including information about quantities and availabilities of temperature sensors, revolutions per minute (RPM) sensors, etc. Example results returned in response to a GET SENSOR REPO INFO request may include:

CPU #1 Voltage
FAN #1 RPM
FAN #2 RPM

To integrate smartNIC IPMI data of the smartNIC 250 with server hardware IPMI data in accordance with examples disclosed herein, the IPMI device driver circuitry 220 intercepts the GET SENSOR REPO INFO request, and the example IPMI smartNIC proxy circuitry 222 forwards the GET SENSOR REPO INFO request (e.g., a command) to the IPMI smartNIC daemon circuitry 244. The example IPMI smartNIC daemon circuitry 244 sends the GET SENSOR REPO INFO request to IPMI hardware plugin circuitry 246. The example IPMI hardware plugin circuitry 246 handles the GET SENSOR REPO INFO request by either: (1) sending the GET SENSOR REPO INFO request to the IPMI device driver circuitry 248 corresponding to the smartNIC 250, or (2) sending GET SENSOR REPO INFO request to a vendor's specific/custom hardware sensor circuitry package if a BMC is not available to collect sensor information. A response from either endpoint (e.g., the IPMI device driver circuitry 248 or the vendor's specific/custom hardware sensor circuitry package) is forwarded back to the IPMI smartNIC proxy circuitry 222. The response includes smartNIC IPMI sensor data that most likely has similar entries to ESXi entries of the server hardware 206 (e.g., CPU #1, FAN #1, etc.). To overcome similar naming conventions for similar sensors of the smartNIC (e.g., sensors that monitor CPUs, fans, etc.), the IPMI smartNIC proxy circuitry 222 modifies the entries of the smartNIC IPMI sensor data response so that a user can identify differences between sensors of the smartNIC 250 and sensors of the server hardware 206. In accordance with examples disclosed herein, the IPMI smartNIC proxy circuitry 222 can create such differentiation by adding a name and PCI ID of the smartNIC 250 to the smartNIC IPMI response/results. Such modified naming scheme can be used to differentiate between sensors of multiple smartNICs in a system. Example modified results could be formatted by the IPMI smartNIC proxy circuitry 222 as follows:

CPU #1 Voltage
FAN #1 RPM
FAN #2 RPM
ACME smartNIC 0000:00:10.0 CPU #1 Voltage
ACME smartNIC 0000:00:10.0 FAN#1 RPM

In the example modified naming convention above, the last two entries starting with ACME correspond to sensor data of the smartNIC 250. In these entries, ACME is the name of the smartNIC 250, and 0000:00:10.0 is the PCI ID of the smartNIC 250. In some examples, the PCI ID is a combination of a device ID (DID) and a vendor ID (VID).

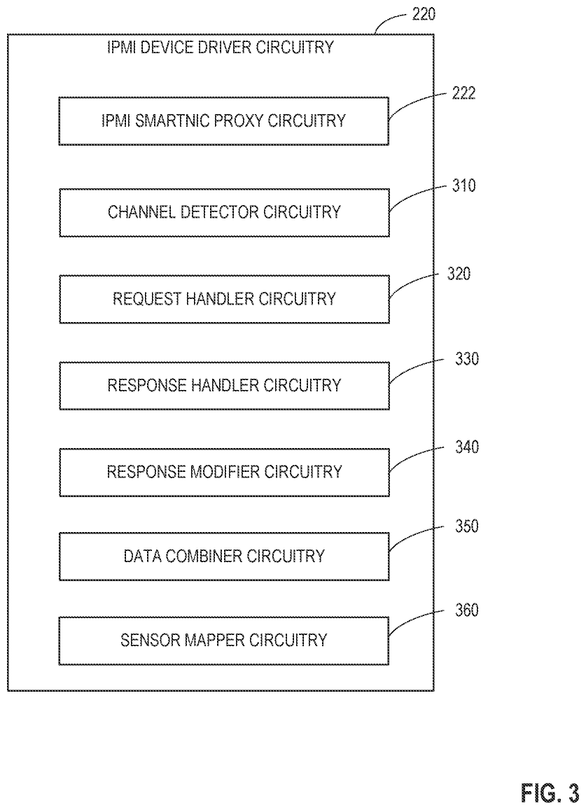

FIG. 3 is a block diagram of the example IPMI device driver circuitry 220 of FIG. 2 to provide access to the example server hardware 206, including, in some examples, the example server hardware BMC 230 and/or the example hypervisor 240. The example IPMI device driver circuitry 220 of FIG. 3 may be instantiated (e.g., creating an instance of, bring into being for any length of time, materialize, implement, etc.) by processor circuitry such as a central processing unit executing instructions. Additionally or alternatively, the example IPMI device driver circuitry 220 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

The example IPMI device driver circuitry 220 of FIG. 2 includes example IPMI smartNIC proxy circuitry 222, example channel detector circuitry 310, example request handler circuitry 320, example response handler circuitry 330, example response modifier circuitry 340, example data combiner circuitry 350, and example sensor mapper circuitry 360.

The example IPMI device driver circuitry 220 is provided with the example IPMI smartNIC proxy circuitry 222 to detect for the presence and/or availability of one or more smartNICs in a system by checking if a kernel-to-kernel NIC is present. As used herein, a kernel-to-kernel NIC is a NIC to facilitate communication between the kernel 204 and an example hypervisor 240, including an example smartNIC 250. In some examples, the presence of a kernel-to-kernel NIC is indicative of a smartNIC because the kernel-to-kernel NIC is implemented in conjunction with the example smartNIC 250. For example, the example kernel-to-kernel NIC 242 would not be present in the hypervisor 240 without the presence of the example smartNIC 250. The example IPMI smartNIC proxy circuitry 222 may, upon confirming the presence of one or more smartNICs available in a system, forward IPMI requests via the example NIC 224. In example FIG. 3, the IPMI smartNIC proxy circuitry 222 is also responsible for receiving responses from a smartNIC (e.g., the smartNIC 250 of FIG. 2), or other responses from a hypervisor platform (e.g., the hypervisor 240 of FIG. 2), and converting the responses into a machine-readable format for the IPMI device driver circuitry 220. The example IPMI smartNIC proxy circuitry 222 may also, in other examples, forward commands to the example IPMI smartNIC daemon circuitry 244 (FIG. 2).

The example channel detector circuitry 310 of FIG. 3 detects channels of communication. For example, the channel detector circuitry 310 determines if a kernel-to-kernel NIC is present, and, therefore, if a smartNIC is present in the system. That is, the example channel detector circuitry 310, upon detecting a communication channel NIC on the system, is able to identify a kernel-to-kernel NIC. The kernel-to-kernel NIC can then be used, for example, by the example IPMI smartNIC proxy circuitry 222 to query the smartNIC for IPMI details, including sensor data.

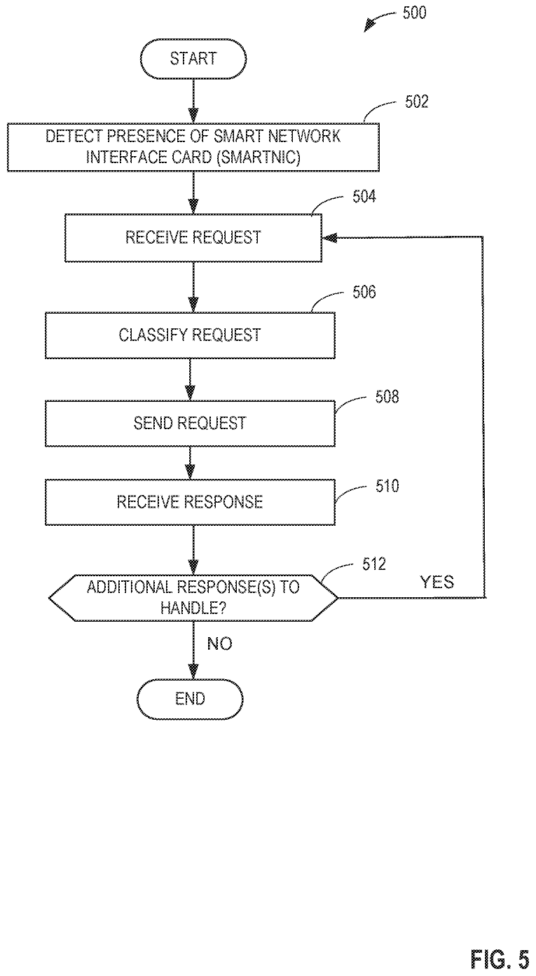

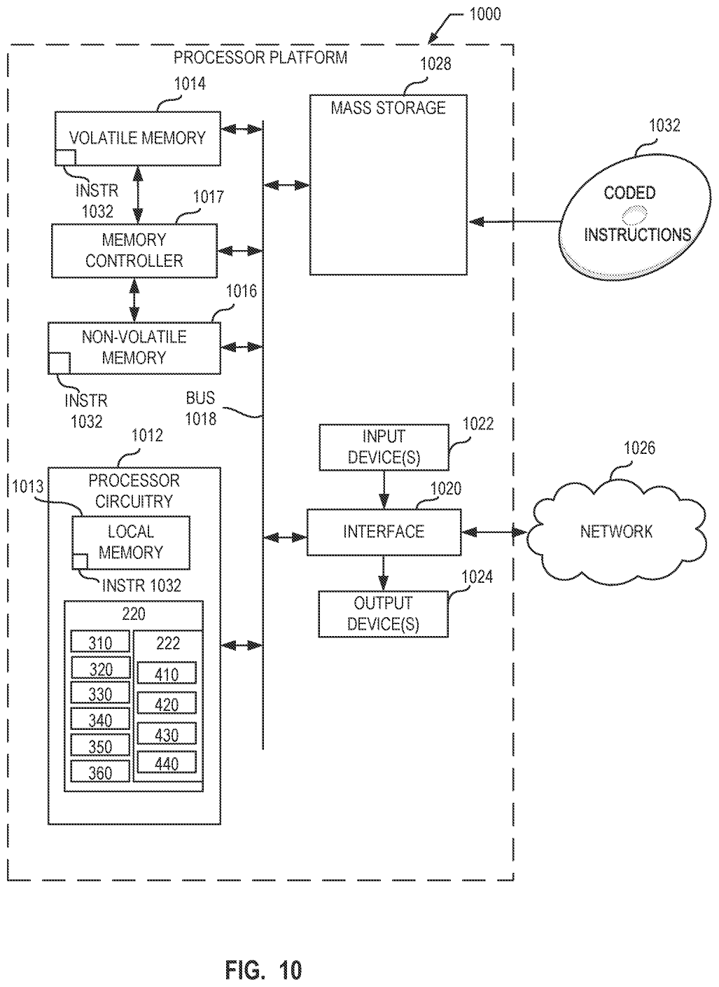

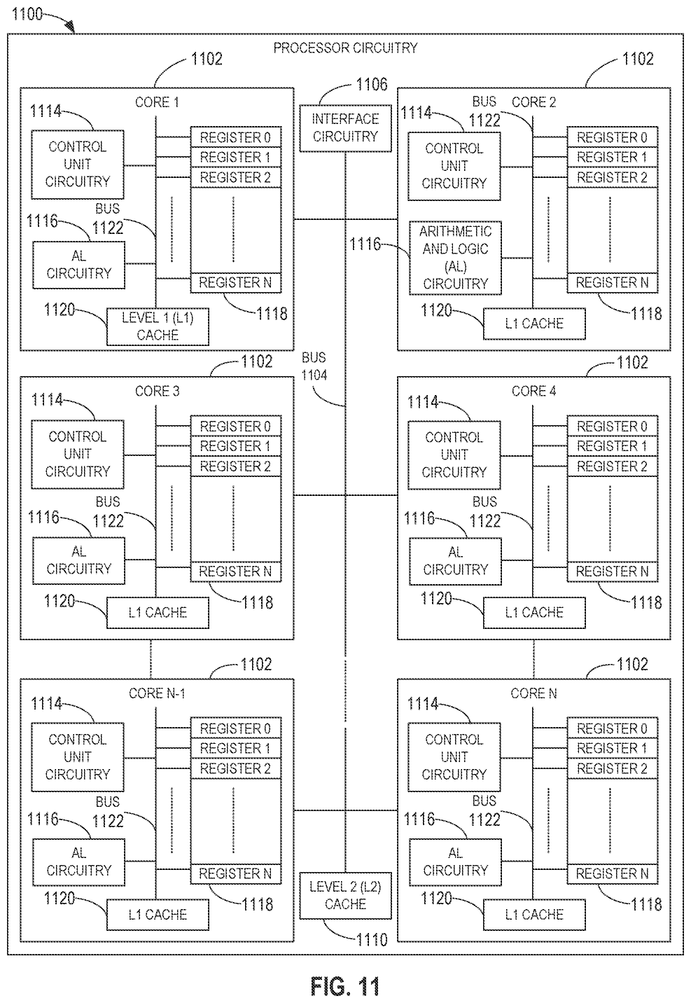

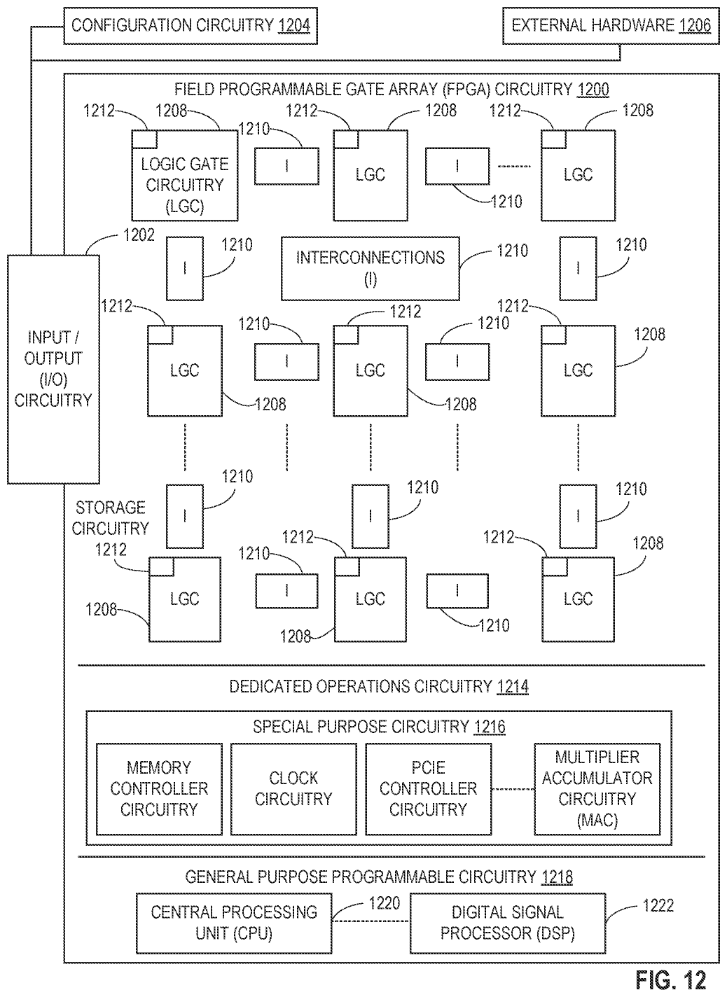

In some examples, apparatus and/or systems implemented in accordance with teachings of this disclosure include means for detecting a communication channel. For example, the means for detecting a communication channel may be implemented by the channel detector circuitry 310. In some examples, the channel detector circuitry 310 may be instantiated by processor circuitry such as the example processor circuitry 1012 of FIG. 10. For instance, the channel detector circuitry 310 may be instantiated by the example microprocessor 1100 of FIG. 11 executing machine executable instructions such as those implemented by at least block 502 of FIG. 5. In some examples, the channel detector circuitry 310 may be instantiated by hardware logic circuitry, which may be implemented by an ASIC, XPU, or the FPGA circuitry 1200 of FIG. 12 structured to perform operations corresponding to the machine readable instructions. Additionally or alternatively, the channel detector circuitry 310 may be instantiated by any other combination of hardware, software, and/or firmware. For example, the channel detector circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example request handler circuitry 320 of FIG. 3 handles requests received by the example IPMI device driver circuitry 220. In some examples, these requests are received from the userspace 202 of FIG. 2. These requests may originate from, for example, the command line interface 210, the virtual machine manager 212, and/or the userspace software 214 of FIG. 2. An example of a request is an example GET SENSOR REPO INFO request which may be used to request information about a quantity of sensors and/or type(s) of sensors in a system. The example request handler circuitry 320 may obtain a request received by the example IPMI device driver circuitry 220 from the userspace 202 via the IPMI character device driver circuitry 216. The example request handler circuitry 320 may also classify a request received by the example IPMI device driver circuitry 220. In some examples, the request handler circuitry 320 may classify a request as either a global IPMI request or a specific IPMI request. As used herein, a global IPMI request is an IPMI request to be handled by both of the example server hardware BMC 230 and the example smartNIC BMC 252 of FIG. 2. As used herein, a specific IPMI request is an IPMI request to be handled by either the example server hardware BMC 230 or the example smartNIC BMC 252, depending on the type of request. For example, a specific IPMI request may be a type 1 request to be handled by the example server hardware BMC 230, or a type 2 request to be handled by the example smartNIC BMC 252. To differentiate between a type 1 request and a type 2 request, the specific IPMI request may include a request type field to include a type identifier specifying type 1 or type 2.

The example IPMI device driver circuitry 220 may include a request-to-category map between IPMI requests and corresponding categories (e.g., type 1 requests, type 2 requests). An example table representing such a request-to-category map is shown below as Table 1.

TABLE 1
Request-to-Category Map

| IPMI Request (NetFn/Cmd) | Category |
|---|---|
| Get SDR (Sensor data record) | Type 1 |
| Info (0x04/0x20) | |
| Get SDR (0x04/0x21) | Type 2 |
| Get Sensor Reading (0x04/0x2D) | Type 2 |
| Get FRU (Field replaceable unit) | Type 1 |
| Inventory Area (0x0A/0x20) | |
| Read FRU (0x0A/0x11) | Type 2 |
| Get SEL (System event log) Info | Type 1 |
| (0x0A/0x40) | |

In example Table 1 above, there are three main components to an IPMI system which include SDRs (Sensor Data Records), FRUs (Field Replaceable Unit), and a SEL (System Event Log). In examples disclosed herein, an SDR is information about a particular sensor on the system. This can include type of sensor such as fan, voltage, temperature, etc. and thresholds corresponding to the sensor. In examples disclosed herein, an FRU is a part of information like serial number, device information, part numbers for replaceable devices in the server, etc. In examples disclosed herein, an SEL is a log which contains events of interest that occur on the server. Items for this include when a sensor goes over temperature, if there is a fan that fails to work, if there is a CPU malfunction, etc. In examples disclosed herein, IPMI requests are identified by a pair of hexadecimal numbers known as a NetFn/Cmd (network function/command).

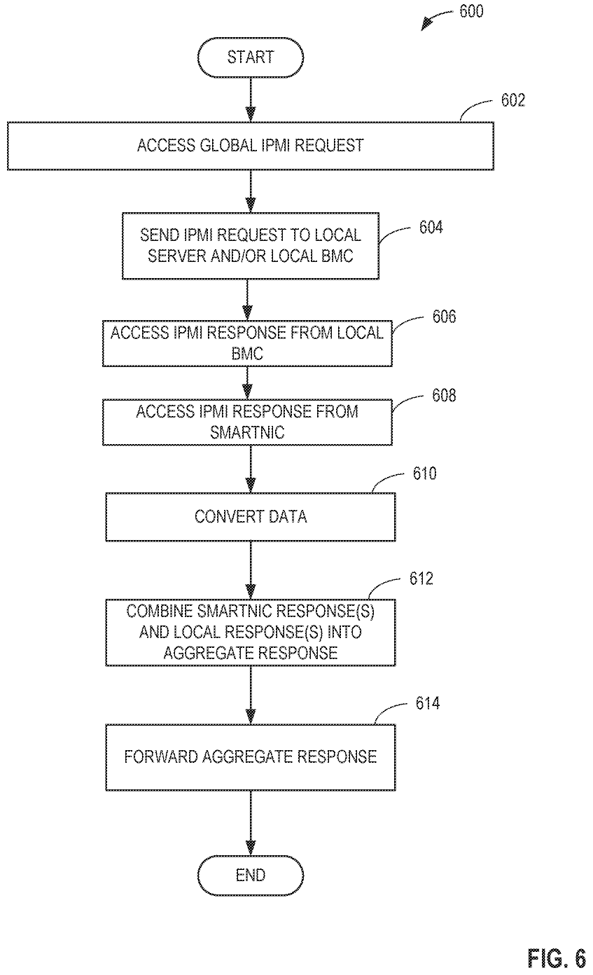

In some examples, apparatus and/or systems implemented in accordance with teachings of this disclosure include means for handling an IPMI request. For example, the means for handling an IPMI request may be implemented by the request handler circuitry 320. In some examples, the request handler circuitry 320 may be instantiated by processor circuitry such as the example processor circuitry 1012 of FIG. 10. For instance, the request handler circuitry 320 may be instantiated by the example microprocessor 1100 of FIG. 11 executing machine executable instructions such as those implemented by at least blocks 504, 506, and/or 508 of FIG. 5, and/or blocks 602 and 604 of FIG. 6. In some examples, the request handler circuitry 320 may be instantiated by hardware logic circuitry, which may be implemented by an ASIC, XPU, or the FPGA circuitry 1200 of FIG. 12 structured to perform operations corresponding to the machine readable instructions. Additionally or alternatively, the request handler circuitry 320 may be instantiated by any other combination of hardware, software, and/or firmware. For example, the request handler circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example response handler circuitry 330 of FIG. 3 handles responses received by the IPMI device driver circuitry 220 from the IPMI smartNIC proxy circuitry 222 of the kernel 204 and/or the server hardware BMC 230 of the server hardware 206. In some examples, these responses are received in response to requests sent by the IPMI device driver circuitry 220 to the server hardware BMC 230 of the server hardware 206 or to the smartNIC BMC 252 of the smartNIC 250. For example, the request handler circuitry 320 may send requests to the server hardware BMC 230 or the smartNIC BMC 252. Such requests instruct the example server hardware BMC 230 and the example smartNIC BMC 252 to return responses to the IPMI device driver circuitry 220. To integrate smartNIC IPMI sensor data (e.g., smartNIC IPMI sensor information) of the smartNIC 250 with server hardware IPMI sensor data (e.g., server hardware IPMI sensor information) a response (e.g., a response including server hardware sensor information) returned from the server hardware BMC 230 is forwarded by the response handler circuitry 330 via the example IPMI smartNIC proxy circuitry 222 and via the NIC 224 to the IPMI smartNIC daemon circuitry 244. In this manner, the smartNIC BMC 252 of the smartNIC 250 can return an updated response that also includes smartNIC IPMI sensor information corresponding to the smartNIC 250. In some examples, the response handler circuitry 330 determines a status of a sensor based on a sensor data record. For example, based on a sensor data record, the sensor may be determined to be at a particular power state (e.g., on, off, power-saving mode, etc.). In some examples, the sensor power state may be the status of the sensor. In other examples, a status of a sensor may be determined to be measuring a particular type of data (e.g., temperature, RPM, etc.). In other examples, the status of a sensor may reflect any other suitable information about the sensor. In some examples, the response handler circuitry 330 causes this status of the sensor to be sent to the userspace 202 (e.g., a client application).

In some examples, apparatus and/or systems implemented in accordance with teachings of this disclosure include means for handling a response that includes, for example, server hardware IPMI data. For example, the means for handling a response may be implemented by the response handler circuitry 330. In some examples, the response handler circuitry 330 may be instantiated by processor circuitry such as the example processor circuitry 1012 of FIG. 10. For instance, the response handler circuitry 330 may be instantiated by the example microprocessor 1100 of FIG. 11 executing machine executable instructions such as those implemented by at least block 510 of FIG. 5, and/or block 606 of FIG. 6. In some examples, the response handler circuitry 330 may be instantiated by hardware logic circuitry, which may be implemented by an ASIC, XPU, or the FPGA circuitry 1200 of FIG. 12 structured to perform operations corresponding to the machine readable instructions. Additionally or alternatively, the response handler circuitry 330 may be instantiated by any other combination of hardware, software, and/or firmware. For example, the response handler circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example response modifier circuitry 340 modifies responses received by the IPMI device driver circuitry 220. In some examples, the responses received by the IPMI device driver circuitry 220 may be in a format unreadable by the IPMI device driver circuitry 220 and may require modifications or conversion to be readable by the example IPMI device driver circuitry 220. For example, the response modifier circuitry 340 may convert data to a readable format (e.g., a machine readable data format such as extensible markup language (XML), JavaScript object notation (JSON), comma-separated values (CSV), etc.) before the data is sent to the userspace 202 of FIG. 2. Example modifications may include converting the response data to another form of machine-readable data, converting the data to an alternative data type (e.g., between different data types such as XML, JSON, CSV, etc.), converting units of data (e.g., between Celsius and Fahrenheit), and/or otherwise modifying the data to be readable by the IPMI device driver circuitry 220, applications in the userspace 202, etc.

In some examples, apparatus and/or systems implemented in accordance with teachings of this disclosure include means for modifying a response. For example, the means for modifying a response may be implemented by the response modifier circuitry 340. In some examples, the response modifier circuitry 340 may be instantiated by processor circuitry such as the example processor circuitry 1012 of FIG. 10. For instance, the response modifier circuitry 340 may be instantiated by the example microprocessor 1100 of FIG. 11 executing machine executable instructions such as those implemented by at least block 610 of FIG. 6. In some examples, the response modifier circuitry 340 may be instantiated by hardware logic circuitry, which may be implemented by an ASIC, XPU, or the FPGA circuitry 1200 of FIG. 12 structured to perform operations corresponding to the machine readable instructions. Additionally or alternatively, the response modifier circuitry 340 may be instantiated by any other combination of hardware, software, and/or firmware. For example, the response modifier circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The IPMI device driver circuitry 220 is provided with the example data combiner circuitry 350 to combine responses received from the smartNIC 250 (FIG. 2) and/or responses received locally from, for example, the server hardware BMC 230, aggregate the responses into an aggregate response, and return the aggregate response to the userspace 202.

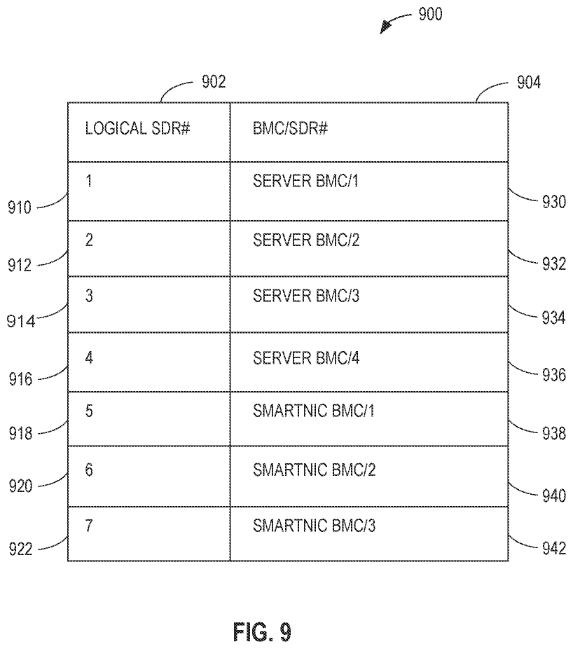

The example data combiner circuitry 350 may be used to aggregate responses to account for sensors corresponding to the server hardware BMC 230 and sensors corresponding to the smartNIC BMC 252. For example, if the server hardware BMC 230 monitors four sensors and the smartNIC BMC 252 monitors three sensors, the server hardware BMC returns a value of four in a Response Data field 2 in response to a Get SDR Count IPMI request. This IPMI request is also forwarded by the example IPMI device driver circuitry 220 to the IPMI smartNIC proxy circuitry 222 which communicates with the NIC 224 (e.g., a vmnic) to export the IPMI request to the smartNIC BMC 252. The IPMI response from the example smartNIC BMC 252 contains a three in a Response Data field 2 in response to a Get SDR Count IPMI request. The example data combiner circuitry 350 of the example IPMI device driver circuitry 220 aggregates these two responses and generates its own IPMI response (e.g., an aggregate IPMI response). A Get SDR Info SDR Count field in the aggregate IPMI response includes the number 7 for its SDR Count. In such example, the IPMI device driver circuitry 220 presents seven logical sensors to a client application in the userspace 202, which accounts for four from the server hardware BMC 230 and three from the smartNIC BMC 252. This information provides the client application availabilities or presences of sensors in a system (e.g., the landscape of hardware sensors in the system). In this manner, the client application can query the individual sensors for readings and/or other information using GET SDR IPMI requests. The example IPMI device driver circuitry 220 keeps a map (e.g., the sensor map 900 of FIG. 9) with these seven logical SDR #identifiers (e.g., logical SDR #column 902) and the BMC/SDR #identifiers (e.g., BMC/SDR #column 904) to which they correspond. The example sensor map 900 can be used when processing requests (e.g., GET SDR IPMI requests) to determine whether a sensor in question is in the server hardware BMC 230 or in the smartNIC BMC 252.

In some examples, apparatus and/or systems implemented in accordance with teachings of this disclosure include means for combining data. For example, the means for converting may be implemented by the data combiner circuitry 350. In some examples, the data combiner circuitry 350 may be instantiated by processor circuitry such as the example processor circuitry 1012 of FIG. 10. For instance, the data combiner circuitry 350 may be instantiated by the example microprocessor 1100 of FIG. 11 executing machine executable instructions such as those implemented by at least block 612 of FIG. 6. In some examples, the data combiner circuitry 350 may be instantiated by hardware logic circuitry, which may be implemented by an ASIC, XPU, or the FPGA circuitry 1200 of FIG. 12 structured to perform operations corresponding to the machine readable instructions. Additionally or alternatively, the data combiner circuitry 350 may be instantiated by any other combination of hardware, software, and/or firmware. For example, the data combiner circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The IPMI device driver circuitry 220 is provided with the example sensor mapper circuitry 360 to maintain an example sensor map to be referenced by the IPMI device driver circuitry 220. An example sensor map maintained by the example sensor mapper circuitry 360 is depicted in FIG. 9. In some examples, the sensor mapper circuitry 360 indicates which sensors are available, for example, locally on a server (e.g., on the server hardware 206 implemented by one of the servers 112, 114, 116, 118, 120, 122 of FIG. 1) and which sensors are running on the smartNIC 250 of FIG. 2. For example, various sensors may be provided to monitor different hardware resources such as CPUs, fans, memory, etc.

In some examples, apparatus and/or systems implemented in accordance with teachings of this disclosure include means for mapping sensors. For example, the means for mapping sensors may be implemented by the sensor mapper circuitry 360. In some examples, the sensor mapper circuitry 360 may be instantiated by processor circuitry such as the example processor circuitry 1012 of FIG. 10. For instance, the sensor mapper circuitry 360 may be instantiated by the example microprocessor 1100 of FIG. 11 executing machine executable instructions to create a sensor map, such as the example sensor map 900 of FIG. 9. In some examples, the sensor mapper circuitry 360 may be instantiated by hardware logic circuitry, which may be implemented by an ASIC, XPU, or the FPGA circuitry 1200 of FIG. 12 structured to perform operations corresponding to the machine readable instructions. Additionally or alternatively, the sensor mapper circuitry 360 may be instantiated by any other combination of hardware, software, and/or firmware. For example, the sensor mapper circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

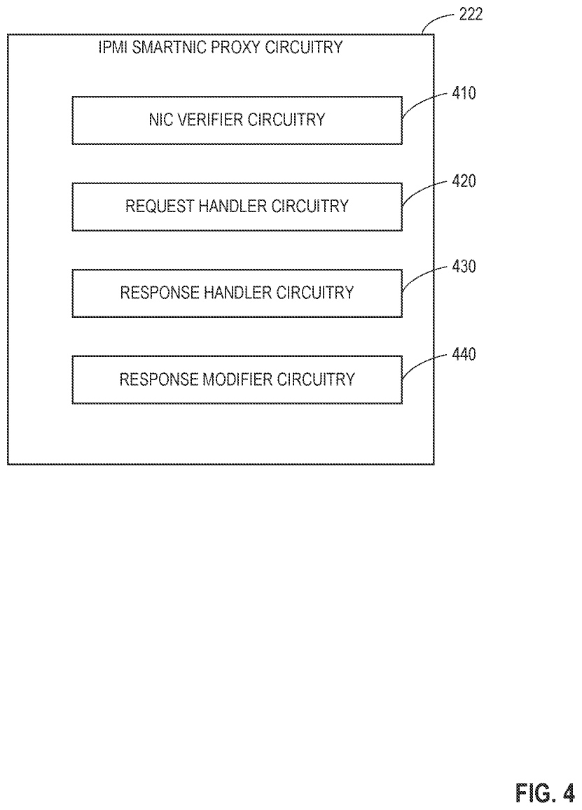

FIG. 4 is a block diagram of example IPMI smartNIC proxy circuitry 222 to detect if there are smartNICs available in a system by checking if a kernel-to-kernel NIC is present. The IPMI smartNIC proxy circuitry 222 may, upon confirming the presence of one or more smartNICs available in a system, forward IPMI requests to the smartNIC BMC 252 via a NIC (e.g., the NIC 224 of FIG. 2). In example FIG. 4, the IPMI smartNIC proxy circuitry 222 receives responses from a smartNIC (e.g., the smartNIC 250 of FIG. 2), or other responses from a hypervisor platform (e.g., the hypervisor 240 of FIG. 2), and converts the response into a machine-readable format for the IPMI device driver circuitry 220. In some examples, the IPMI smartNIC proxy circuitry 222 forwards commands to the example IPMI smartNIC daemon circuitry 244.

The example IPMI smartNIC proxy circuitry 222 of FIG. 4 may be instantiated (e.g., creating an instance of, bring into being for any length of time, materialize, implement, etc.) by processor circuitry such as a central processing unit executing instructions. Additionally or alternatively, the IPMI smartNIC proxy circuitry 222 of FIG. 4 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by microprocessor circuitry executing instructions to implement one or more virtual machines and/or containers.

The example IPMI smartNIC proxy circuitry 222 includes example NIC verifier circuitry 410, example request handler circuitry 420, example response handler circuitry 430, and example response modifier circuitry 440.

The example NIC verifier circuitry 410 verifies the presence of a NIC (e.g., the NIC 224 of FIG. 2) in a system (e.g., the computer virtualization system 200 of FIG. 2). In response to a request received from the IPMI device driver circuitry 220, the example NIC verifier circuitry 410 verifies the presence of a smartNIC in the system (e.g., the computer virtualization system 200 of FIG. 2). In some examples, the NIC verifier circuitry 410 may verify that at least one smartNIC is present in the system by verifying the presence of the NIC 224.

In some examples, apparatus and/or systems implemented in accordance with teachings of this disclosure include means for verifying the presence of a NIC. For example, the means for verifying the presence of a NIC may be implemented by the NIC verifier circuitry 410. In some examples, the NIC verifier circuitry 410 may be instantiated by processor circuitry such as the example processor circuitry 1012 of FIG. 10. For instance, the NIC verifier circuitry 410 may be instantiated by the example microprocessor 1100 of FIG. 11 executing machine executable instructions such as those implemented by at least block 502 of FIG. 5. In some examples, the NIC verifier circuitry 410 may be instantiated by hardware logic circuitry, which may be implemented by an ASIC, XPU, or the FPGA circuitry 1200 of FIG. 12 structured to perform operations corresponding to the machine readable instructions. Additionally or alternatively, the NIC verifier circuitry 410 may be instantiated by any other combination of hardware, software, and/or firmware. For example, the NIC verifier circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example request handler circuitry 420 handles requests. In some examples, the request handler circuitry 420 forwards a request to the hypervisor 240, including to the IPMI smartNIC daemon circuitry 244 and/or the smartNIC BMC 252. In some examples disclosed herein, requests handled by the request handler circuitry 420 are to be forwarded to the smartNIC 250.

In some examples, apparatus and/or systems implemented in accordance with teachings of this disclosure include means for handling an IPMI request. For example, the means for handling an IPMI request may be implemented by the request handler circuitry 420. In some examples, the request handler circuitry 420 may be instantiated by processor circuitry such as the example processor circuitry 1012 of FIG. 10. For instance, the request handler circuitry 420 may be instantiated by the example microprocessor 1100 of FIG. 11 executing machine executable instructions such as those implemented by at least block 604 of FIG. 6. In some examples, the request handler circuitry 420 may be instantiated by hardware logic circuitry, which may be implemented by an ASIC, XPU, or the FPGA circuitry 1200 of FIG. 12 structured to perform operations corresponding to the machine readable instructions. Additionally or alternatively, the request handler circuitry 420 may be instantiated by any other combination of hardware, software, and/or firmware. For example, the request handler circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example response handler circuitry 430 handles responses received by the IPMI smartNIC proxy circuitry 222. In some examples, these responses may include responses with smartNIC IPMI sensor data received from the IPMI device driver circuitry 248 corresponding to the smartNIC 250, responses with server hardware IPMI sensor data received from the server hardware BMC 230 of the server hardware 206, and/or responses received from a specific hardware sensor via vendor-provided custom software that reads sensors. In some examples, responses handled by the response handler circuitry 430 are to be combined into an aggregate response so that aggregate responses can be forwarded to the userspace 202.

In some examples, apparatus and/or systems implemented in accordance with teachings of this disclosure include means for handling a response. For example, the means for handling may be implemented by the response handler circuitry 430. In some examples, the response handler circuitry 430 may be instantiated by processor circuitry such as the example processor circuitry 1012 of FIG. 10. For instance, the response handler circuitry 430 may be instantiated by the example microprocessor 1100 of FIG. 11 executing machine executable instructions such as those implemented by at least blocks 606 and/or 608 of FIG. 6. In some examples, the response handler circuitry 430 may be instantiated by hardware logic circuitry, which may be implemented by an ASIC, XPU, or the FPGA circuitry 1200 of FIG. 12 structured to perform operations corresponding to the machine readable instructions. Additionally or alternatively, the response handler circuitry 430 may be instantiated by any other combination of hardware, software, and/or firmware. For example, the response handler circuitry 430 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example response modifier circuitry 440 modifies responses received by the example IPMI smartNIC proxy circuitry 222. For example, the response modifier circuitry 440 may receive a request from the IPMI smartNIC proxy circuitry 222 and modify the request by replacing a smartNIC sensor data record (SDR) identifier in the request with a logical SDR identifier. In examples disclosed herein, a smartNIC SDR identifier is an SDR identifier included in an example response from the example smartNIC 250. In examples disclosed herein, a logical SDR identifier is an identifier based on an example sensor map. The logical SDR identifier is used to differentiate a smartNIC SDR from a server hardware BMC SDR. For example, the example response modifier circuitry 440 may replace a smartNIC SDR identifier with a logical SDR identifier to differentiate between an example smartNIC SDR identifier and an example server hardware BMC SDR identifier. For example, a smartNIC SDR identifier “CPU 1 Temp SDR” may be replaced by the example response modifier circuitry 440 with “smartNIC CPU 1 Temp” to distinguish that it is a smartNIC SDR identifier. Additionally or alternatively, the example response modifier circuitry 440 may return a response to the response modifier circuitry 340 of the IPMI device driver circuitry 220 so that the response modifier circuitry 340 can modify the response by converting data into a machine-readable format and forward the modified response to the userspace 202, the response containing information received regarding the server hardware 206.

In some examples, apparatus and/or systems implemented in accordance with teachings of this disclosure include means for modifying a response. For example, the means for modifying a response may be implemented by the response modifier circuitry 440. In some examples, the response modifier circuitry 440 may be instantiated by processor circuitry such as the example processor circuitry 1012 of FIG. 10. For instance, the response modifier circuitry 440 may be instantiated by the example microprocessor 1100 of FIG. 11 executing machine executable instructions such as those implemented by at least block 610 of FIG. 6. In some examples, the response modifier circuitry 440 may be instantiated by hardware logic circuitry, which may be implemented by an ASIC, XPU, or the FPGA circuitry 1200 of FIG. 12 structured to perform operations corresponding to the machine readable instructions. Additionally or alternatively, the response modifier circuitry 440 may be instantiated by any other combination of hardware, software, and/or firmware. For example, the response modifier circuitry 440 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the IPMI device driver circuitry 220 of FIG. 2 is illustrated in FIGS. 3 and 4, one or more of the elements, processes, and/or devices illustrated in FIGS. 3 and 4 may be combined, divided, re-arranged, omitted, eliminated, and/or implemented in any other way. Further, the example IPMI smartNIC proxy circuitry 222, the example channel detector circuitry 310, the example request handler circuitry 320, the example response handler circuitry 330, the example response modifier circuitry 340, the example data combiner circuitry 350, and/or the example sensor mapper circuitry 360, the example NIC verifier circuitry 410, the example request handler circuitry 420, the example response handler circuitry 430, the example response modifier circuitry 440, and/or, more generally, the example IPMI device driver circuitry 220 of FIG. 1, may be implemented by hardware alone or by hardware in combination with software and/or firmware. Thus, for example, any of the example IPMI smartNIC proxy circuitry 222, the example channel detector circuitry 310, the example request handler circuitry 320, the example response handler circuitry 330, the example response modifier circuitry 340, the example data combiner circuitry 350, and/or the example sensor mapper circuitry 360, the example NIC verifier circuitry 410, the example request handler circuitry 420, the example response handler circuitry 430, the example response modifier circuitry 440, and/or, more generally, the example IPMI device driver circuitry 220 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example IPMI device driver circuitry 220 of FIG. 3 may include one or more elements, processes, and/or devices in addition to, or instead of, those illustrated in FIGS. 3 and 4, and/or may include more than one of any or all of the illustrated elements, processes and devices.

A flowchart representative of example machine readable instructions, which may be executed to configure processor circuitry to implement the IPMI device driver circuitry 220 of FIG. 2, is shown in FIGS. 5, 6, and 7. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 5-7, many other methods of implementing the example IPMI device driver circuitry 220 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to implement the example IPMI device driver circuitry 220 of FIG. 2 to forward IPMI requests to the server hardware BMC 230 of FIG. 2 and/or to the smartNIC BMC 252 of FIG. 2. The machine readable instructions and/or the operations 500 of FIG. 5 begin at block 502, at which the example channel detector circuitry 310 (FIG. 3) detects the presence of a smart network interface card (smartNIC) in the computer virtualization system 200 (FIG. 2). In some examples, the channel detector circuitry 310 determines that there is a smartNIC in the computer virtualization system 200 by detecting the presence of a kernel-to-kernel network interface card (NIC) in the computer virtualization system 200. For example, in the computer virtualization system 200 of FIG. 2, the NIC 224 and the NIC 242 are kernel-to-kernel NICs because the NIC 224 operates in the kernel 204, the NIC 242 operates in the hypervisor 240, and the NIC 224 and the NIC 242 communicate with one another across kernel 204 and the hypervisor 240. Thus, the channel detector circuitry 310 determines the presence of a smartNIC in the computer virtualization system 200 by obtaining network topology information from the NIC 224 indicative that the NIC 224 operates in the kernel 204 and is in communication with the NIC 242 operating in the hypervisor 240. In some examples, the channel detector circuitry 310 sends an instruction to the example NIC verifier circuitry 410 to identify the kernel-to-kernel NIC. In some examples, a kernel-to-kernel NIC is a communication channel NIC, which facilitates communication between the server hardware 206 and an example smartNIC 250. In some examples, the channel detector circuitry 310 of the IPMI device driver circuitry 220 can be modified to detect if this communication channel NIC is present, and therefore if a smartNIC is present in the computer virtualization system 200.

The example request handler circuitry 320 (FIG. 3) receives a request. (Block 504). In some examples, the request may be a user-inputted request received from the command line interface 210 of FIG. 2. In other examples, this request may be any type of request provided by the example virtual machine manager 212 and/or the userspace software 214. In any case, the request handler circuitry 320 receives the request after the request is communicated from the userspace 202 to the IPMI character device driver circuitry 216. In some examples, this request may be a GET SENSOR REPO INFO request that includes a query requesting information indicative of a quantity and/or type(s) of sensors available in the computer virtualization system 200.

The example request handler circuitry 320 classifies the request. (Block 506). In some examples, the request handler circuitry 320 classifies a request as a global request type, which should be directed to both the example server hardware BMC 230 and the example smartNIC BMC 252, or a specific request type, which should be directed to only one of the example server hardware BMC 230 or the example smartNIC BMC 252. If the request is of the specific request type, the request is further categorized by request subset type. For example, one specific request subset type is server BMC request type to indicate that the request is intended for the example server hardware BMC 230 which is outside the smartNIC 250 in the server hardware 206. Another example request subset type is a smartNIC BMC request type to indicate that the request is intended for the example smartNIC BMC 252 in the smartNIC 250 of the server hardware 206. In some examples, to determine whether a request is a global request or a specific request, the request handler circuitry 320 may refer to one or more sensor maps (e.g., the resource map 900 of FIG. 9) maintained by the example sensor mapper circuitry 360 (FIG. 3). For example, according to the sensor map 900 of FIG. 9, if the request includes one or more logical SDR #values of 1, 2, 3, or 4 and one or more logical SDR #values of 5, 6, or 7, the request is a global request because the combination of logical SDR #values indicate the request is for IPMI sensor information from both the server hardware BMC 230 of the server hardware 206 and the smartNIC BMC 252 of the smartNIC 250. If the request includes one or more logical SDR #values of 1, 2, 3, or 4 without any logical SDR #values of 5, 6, or 7, the request is a specific request of server BMC request type. If the request includes one or more logical SDR #values of 5, 6, or 7 without any logical SDR #values of 1, 2, 3, or 4, the request is a specific request of smartNIC BMC request type. In some examples, various IPMI request types that may be received by the request handler circuitry 320 are based on sensor map(s) maintained by the example sensor mapper circuitry 360. In some examples, the request handler circuitry 320, in response to identifying the type of request in a sensor map, classifies the request as either a type 1 request (e.g., a global request type), a type 2a request (e.g., a server BMC request type to be directed to the server hardware BMC 230), or a type 2b request (e.g., a smartNIC BMC request type to be directed to the smartNIC BMC 252 in the smartNIC 250).

The example request handler circuitry 320 sends the request. (Block 508). In example FIG. 5, the request handler circuitry sends the request to the server hardware BMC 230 and/or the smartNIC BMC 252 based on its classified request type. For example, the smartNIC BMC 252 may be the destination of a global IPMI request and/or a specific IPMI request, and in some examples, the request handler circuitry 320 sends the request to the IPMI smartNIC proxy circuitry 222 so that the IPMI smartNIC proxy circuitry 222 can send the request to the server hardware 206 via a kernel-to-kernel NIC such as the example NIC 224 in communication with the NIC 242. In some examples, the request received and classified by the request handler circuitry 320 is a GET SENSOR REPO INFO request, a Get Device SDR Info request, or any other request to obtain sensor information such as a number and/or type(s) of sensors available in the computer virtualization system 200 (FIG. 2).

The response handler circuitry 330 (FIG. 3) receives a response. (Block 510). In example FIG. 5, the response is responsive to the request sent at block 508. For example, the response may be sent by the server hardware BMC 230, or it may be sent by the smartNIC BMC 252 by way of the IPMI smartNIC proxy circuitry 222, and received by the response handler circuitry 330. In some examples, the response includes sensor data (e.g., server hardware IPMI sensor information or smartNIC IPMI sensor information).

The example request handler circuitry 320 determines if there are additional requests to handle. (Block 512). In response to the example request handler circuitry 320 identifying at least one additional response to handle (block 512: YES), control returns to block 504. In response to the example request handler circuitry 320 determining there is no additional response to handle (block 512: NO), the example instructions of FIG. 5 end.

FIG. 6 is a flowchart representative of example machine readable instructions and/or example operations 600 that may be executed and/or instantiated by processor circuitry to implement the example IPMI device driver circuitry 220 of FIG. 2 to access and handle a global IPMI request. The machine readable instructions and/or the operations 600 of FIG. 6 begin at block 602, at which the example request handler circuitry 320 (FIG. 3) accesses a global IPMI request. For example, the global IPMI request may be received from the an application in the userspace 202. The global IPMI request may be a GET SENSOR REPO INFO request, a Get Device SDR Info request, or any other request to obtain sensor information.

The example request handler circuitry 320 sends the request to be received by at least one of the example server hardware BMC 230 and/or the smartNIC BMC 252 (FIG. 2). (Block 604). In some examples, the server hardware BMC 230 and/or the smartNIC BMC 252 handles the request to obtain sensor data information. In some examples, the example request handler circuitry 320 may send an instruction to the example request handler circuitry 420 of the IPMI smartNIC proxy circuitry 222 to transmit an instruction to the smartNIC BMC 252 via a kernel-to-kernel NIC such as the example NIC 224. The NIC 242 may then receive the request from the example NIC 224 and forwards the request to the example IPMI smartNIC daemon circuitry 244 to be forwarded to the smartNIC BMC 252. In other examples, the server hardware 206 and/or the smartNIC 250 may include a vendor's specific/custom hardware sensor circuitry package instead of or in addition to the server hardware BMC 230 and/or the smartNIC BMC 252. In such examples, the specific/custom hardware sensor circuitry may read sensors to obtain sensor information and include such sensor information in a response to the request.

The example response handler circuitry 330 (FIG. 3) of the IPMI device driver circuitry 220 accesses an IPMI response from the example server hardware BMC 230. (Block 606). In some examples, the IPMI response received from the example server hardware BMC 230 by the example response handler circuitry 330 includes sensor information.

The example response handler circuitry 430 (FIG. 4) of the IPMI smartNIC proxy circuitry 222 accesses another IPMI response from the example smartNIC 250. (Block 608). In some examples, the IPMI response from the smartNIC 250 is from the smartNIC BMC 252 in the smartNIC 250. The example response accessed by the IPMI smartNIC proxy circuitry 222 at block 608 may include sensor information.

The example response modifier circuitry 340 (FIG. 3) and/or the example response modifier circuitry 440 converts data. (Block 610). For example, the response modifier circuitry 340 may receive a response from the server hardware BMC 230 and convert the data to a different data type, or otherwise process the data. In other examples, the response modifier circuitry 440 may receive a response from the smartNIC BMC 252 and convert the data to a different data type, or otherwise process the data.

The example data combiner circuitry 350 (FIG. 3) combines multiple responses into an aggregate response. (Block 612). For example, the data combiner circuitry 350 may receive one or more other responses from the server hardware BMC 230 and/or the smartNIC BMC 252, and the data combiner circuitry 350 may combine or aggregate the multiple responses into an aggregate response. In some examples, the aggregate response may be created so that multiple responses can be forwarded as a single response to the userspace 202, rather than as several responses of differing data formats.

The example data combiner circuitry 350 sends the aggregate response to the userspace 202 (Block 614). In some examples, the example data combiner circuitry 350 sends the aggregate response to an application in the userspace 202 in response to accessing the global IPMI request. The instructions of FIG. 6 end.

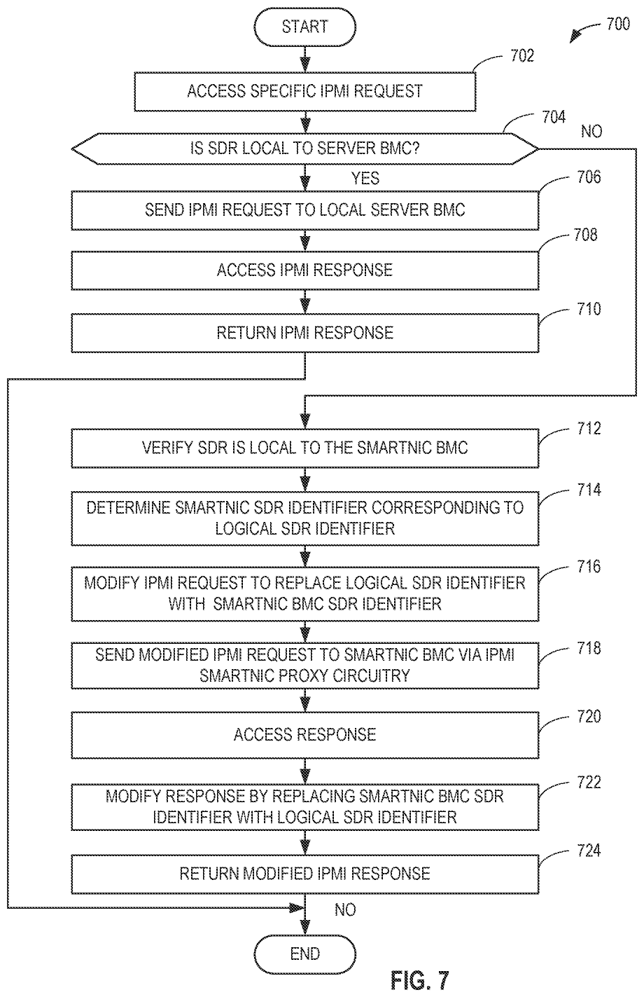

FIG. 7 is a flowchart representative of example machine readable instructions and/or example operations 700 that may be executed and/or instantiated by processor circuitry to implement the example IPMI device driver circuitry 220 of FIG. 2 to access and handle a specific IPMI request. The machine readable instructions and/or the operations 700 of FIG. 7 begin at block 702, at which the example request handler circuitry 320 accesses a specific IPMI request. (Block 702).

The example request handler circuitry 320 verifies if the request is for a SDR local to the example server hardware BMC 230. (Block 704). For example, the request handler circuitry 320 can determine whether the request is for a SDR that is local (e.g., in the server hardware 206) relative to the server hardware BMC 230 by identifying a logical SDR #of the request on an example sensor map (e.g., the sensor map 900 of FIG. 9) maintained by the example sensor mapper circuitry 360. That is, the request handler circuitry 320 can find a match between the logical SDR #of the request and one of the records 910, 912, 914, 916 corresponding to the server hardware BMC 230 in the sensor map 900.

If the example request handler circuitry 320 determines that the request is for a SDR that is local to the server hardware BMC 230 (block 704: YES), the example request handler circuitry 320 sends the IPMI request to the example server hardware BMC 230. (Block 706).

The example response handler circuitry 330 accesses a server hardware IPMI response from the server hardware BMC 230. (Block 708). For example, the returned server hardware IPMI response includes server hardware IPMI sensor data.

The example response handler circuitry 330 returns the server hardware IPMI response. (Block 710). For example, the example response modifier circuitry 340 forwards the server hardware IPMI response to an application in the userspace 202, including, in some examples, the example command line interface 210, or a different software application in the userspace 202. In example FIG. 7, the server hardware IPMI response is in response to the specific IPMI request received by the IPMI device driver circuitry 220 (e.g., the specific IPMI request accessed at block 702).

If the example request handler circuitry 320 determines that the specific IPMI request is for a SDR that is not local to the server hardware BMC 230 (e.g., block 704 returns a result of NO), the example request handler circuitry 320 verifies that the specific IPMI request is for a SDR that is local to the smartNIC BMC 252. (Block 712). For example, the request handler circuitry 320 can verify that the specific IPMI request is for a SDR that is local to the smartNIC BMC 252 by identifying a logical SDR #of the request on an example sensor map (e.g., the sensor map 900 of FIG. 9) maintained by the example sensor mapper circuitry 360. That is, the request handler circuitry 320 can find a match between the logical SDR #of the specific IPMI request and one of the records 918, 920, 922 corresponding to the smartNIC BMC 252 in the sensor map 900.

The example request handler circuitry 420 determines the smartNIC SDR identifier corresponding to the logical SDR identifier (Block 714). For example, the request handler circuitry 420 of the IPMI smartNIC proxy circuitry 222 accesses the sensor map 900 maintained by the sensor mapper circuitry 360 which defines which SDRs are local relative to the server hardware BMC 230 and which SDRs are located on the smartNIC 250. That is, before the IPMI smartNIC proxy circuitry 222 forwards the specific IPMI request to the smartNIC 250, the example request handler circuitry 420 uses the sensor map 900 to translate the logical SDR #identifier in the specific IPMI request to the mapped BMC SDR #corresponding to the smartNIC 250.

The example request handler circuitry 420 and/or the example response modifier circuitry 440 modifies the SDR number in the specific IPMI request by replacing its logical SDR #with the corresponding smartNIC BMC SDR #associated with the smartNIC BMC 252. (Block 716). For example, if the specific IPMI request is a Get SDR request received by the request handler circuitry 320 for logical SDR #5, at least one of the request handler circuitry 420 or the example response modifier circuitry 440 is employed to remove the logical SDR #5 from the Get SDR request and replace it with the smartNIC BMC SDR #1 corresponding to the smartNIC BMC 252 based on a fifth record 918 of the sensor map 900.

The example IPMI smartNIC proxy circuitry 222 sends the modified IPMI request to the smartNIC BMC 252. (Block 718). For example, the IPMI smartNIC proxy circuitry 222 can send the modified IPMI request to the smartNIC BMC 252 via the IPMI smartNIC daemon circuitry 244.

The example response handler circuitry 430 accesses a smartNIC IPMI response from the smartNIC BMC 252 via the IPMI smartNIC daemon circuitry 244. (Block 720). For example, the smartNIC IPMI response includes smartNIC IPMI sensor information from the smartNIC BMC 252 in response to the modified IPMI request sent at block 718.

The example response modifier circuitry 440 modifies the smartNIC IPMI response from the smartNIC BMC 252 by replacing a smartNIC SDR identifier in the smartNIC IPMI response with a logical SDR identifier. (Block 722). For example, if the smartNIC BMC SDR #is set to the value 1 coming back from the smartNIC BMC 252, the response modifier circuitry 440 converts this back to its logical SDR identifier value of 5 in accordance with example sensor map 900 of FIG. 9 (e.g., the fifth record 918 of FIG. 9). In addition to this logical SDR #value, there may be other fields that need to be changed in a similar fashion by the response modifier circuitry 440 of the IPMI smartNIC proxy circuitry 222 before the smartNIC IPMI response is returned to the userspace 202 (e.g., a user application, the command line interface 210, the virtual machine manager 212, and/or the userspace software 214). In some examples, an ID string or logical SDR #value for the server hardware BMC 230 may be CPU #0. In some examples, such a logical SDR #value may overlap with a logical SDR #value of the smartNIC BMC 252, as the smartNIC BMC 252 may also have a CPU #0. This issue can be resolved by the response modifier circuitry 440 prepending the smartNIC Vendor Name and PCI ID onto the ID string or logical SDR #value. For example, CPU #0 for an ACME smartNIC at PCI location 0000:00:10.0 can be modified by the response modifier circuitry 440 to appear as “ACME smartNIC 0000:00:10.0 CPU #0”.

The example response handler circuitry 430 or the example response handler circuitry 330 returns the modified smartNIC IPMI response to an application in the userspace 202 (e.g., the example command line interface 210, the virtual machine manager 212, the userspace software 214, and/or a different software application in the userspace 202). (Block 724). In example FIG. 7, the modified smartNIC IPMI response is sent to the userspace 202 in response to the specific IPMI request accessed at block 702. In example FIG. 7, after the response handler circuitry 330 returns the server hardware IPMI response at block 710, or after the response handler circuitry 430 or the example response handler circuitry 330 returns the modified smartNIC IPMI response at block 724, the instructions of FIG. 7 end.

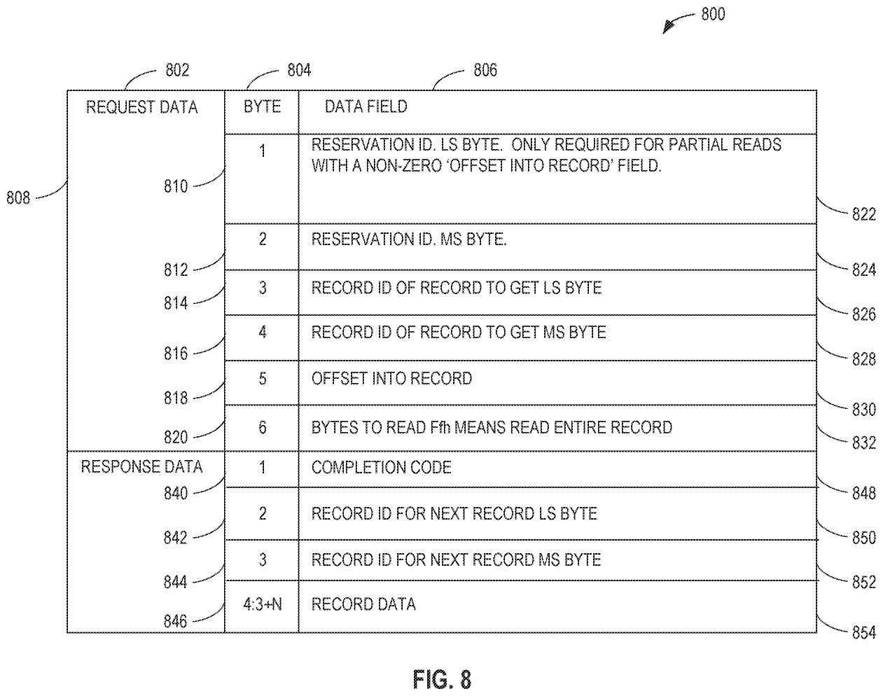

FIG. 8 is an example table 800 representative of information associated with a get sensor data record (SDR) request to obtain SDR information. The example table 800 of FIG. 8 includes a first column 802 of data types, including request data and response data; a second column 804 representing a byte, and a third column 806 representing a data field. The example table 800 includes a first byte of request data 810, a second byte of request data 812, a third byte of request data 814, a fourth byte of request data 816, a fifth byte of request data 818, and a sixth byte of request data 820. The example table 800 includes a first data field 822, a second data field 824, a third data field 826, a fourth data field 828, a fifth data field 830, and a sixth data field 832. The example table 900 also includes a first byte of response data 840, a second byte of response data 842, a third byte of response data 844, and a fourth byte of response data 846. The example table 800 includes a seventh data field 848, an eighth data field 850, a ninth data field 852, and a tenth data field 854. The table of FIG. 8 may be referenced by the IPMI device driver circuitry 220 to generate an SDR request to obtain device SDR info, including information regarding instructions about sensor data.

FIG. 9 includes an example sensor map 900 which may be maintained by the example sensor mapper circuitry 360 of FIG. 4 or the example IPMI device driver circuitry 220 of FIG. 2. The example sensor map 900 may also be defined as an example resource map 900. The example sensor map 900 of FIG. 9 includes a logical SDR #column 902 and a BMC/SDR #column 904. In the illustrated example of FIG. 9, the sensor map 900 includes seven records, including a first record 910, a second record 912, a third record 914, a fourth record 916, and fifth record 918, a sixth record 920, and a seventh record 922. These records each have corresponding information in the BMC/SDR #column 904, including first sensor information 930, second sensor information 932, third sensor information 934, fourth sensor information 936, fifth sensor information 938, sixth sensor information 940, and seventh sensor information 942. The example sensor map 900 of FIG. 9 corresponds to an example in which the server hardware BMC 230 communicates with four sensors (e.g., SERVER BMC/1, SERVER BMC/2, SERVER BMC/3, SERVER BMC/4), and the smartNIC BMC 252 communicates with three sensors (e.g., SMARTNIC BMC/1, SMARTNIC BMC/2, SMARTNIC BMC/3). In some examples, the IPMI device driver circuitry 220 may receive a request to identify a number of sensors/SDRs available in the system. In some examples, the IPMI device driver circuitry 220 may receive this request from an application from the example userspace 202. In some examples, upon receiving the request to identify a number of sensors/SDRs available on the system, the IPMI device driver circuitry 220 may forward the request to the server hardware BMC 230 and the smartNIC BMC 252. In such examples, the server hardware BMC 230 returns a response of four in a response data field corresponding to a get SDR count request. In such examples, the response of four indicates that the server hardware BMC 230 communicates with (e.g., monitors, manages, etc.) four sensors. Also in such examples, the response from the server hardware BMC 230 also includes server BMC SDR #identifier values corresponding to the different sensors monitored and/or managed by the server hardware BMC 230. In addition, the example smartNIC BMC 252 may return a response of three in a response data field corresponding to a get SDR count request. In such examples, a get SDR count request is to obtain a value indicative of a total number of SDRs in a device. For example, the response of three indicates that the smartNIC BMC 252 communicates with (e.g., monitors, manages, etc.) three sensors. In some examples, the example smartNIC BMC 252 may return a response indicative of the number of sensors in the device in response to a Get Sensor Count request. In some examples, a response from the smartNIC BMC 252 also includes smartNIC BMC SDR #identifier values corresponding to the different sensors monitored and/or managed by the smartNIC BMC 252. Based on the responses from the server hardware BMC 230 and the smartNIC BMC 252, the IPMI device driver circuitry 220 populates the example sensor map 900 to include the information received in the responses from the server hardware BMC 230 and the smartNIC BMC 252. As depicted in the example sensor map 900 of FIG. 9, the first record 910, the second record 912, the third record 914, and the fourth record 916 include SDR #mappings for a “SERVER BMC”, and the fifth record 918, the sixth record 920, and the seventh record 922 include SDR #mappings for a “SMARTNIC BMC.” These mappings are stored in memory for later use by the IPMI device driver circuitry 220, and are used to map logical SDR #values to IPMI sensor information in responses received by the IPMI device driver circuitry 220 from the example server hardware BMC 230 and the example smartNIC BMC 252. In some examples, the data in the example sensor map 900 may indicate that the sensor is associated with a particular server (e.g., a local server, etc.).

Although the sensor map 900 of FIG. 9 shows naming conventions of “server BMC” and “smartNIC BMC”, examples disclosed herein may be implemented for sensors that are not associated with a BMC. In such examples, a sensor map such as the sensor map 900 may be generated to include SDR identifiers for non-BMC sensors. As described above, a vendor's specific/custom hardware sensor circuitry package may be used to collect sensor information from non-BMC sensors.

FIG. 10 is a block diagram of an example processor platform 1000 structured to execute and/or instantiate the machine readable instructions and/or the operations of FIGS. 5-7 to implement the apparatus of FIG. 2. The processor platform 1000 can be, for example, a server, a personal computer, a workstation, a self-learning machine (e.g., a neural network), or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements example IPMI character device driver circuitry 216, example IPMI device driver circuitry 220, example IPMI smartNIC proxy circuitry 222, example channel detector circuitry 310, example request handler circuitry 320, example response handler circuitry 330, example response modifier circuitry 340, example data combiner circuitry 350, example sensor mapper circuitry 360, example NIC verifier circuitry 410, example request handler circuitry 420, example response handler circuitry 430, and/or example response modifier circuitry 440.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1010, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIGS. 5, 6, and/or 7 may be stored in the mass storage device 1028, in the volatile memory 1014, in the non-volatile memory 1016, and/or on a removable non-transitory computer readable storage medium such as a CD or DVD.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowcharts of FIGS. 5-7 to effectively instantiate the circuitry of FIG. 2 as logic circuits to perform the operations corresponding to those machine readable instructions. In some such examples, the circuitry of FIG. 2 is instantiated by the hardware circuits of the microprocessor 1100 in combination with the instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowchart of FIGS. 5-7.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 12 is a block diagram of another example implementation of the processor circuitry 1012 of FIG. 10. In this example, the processor circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1012 of FIG. 10 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowchart of FIGS. 5-7 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowchart of FIGS. 5-7. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIGS. 5-7. As such, the FPGA circuitry 1200 may be structured to effectively instantiate some or all of the machine readable instructions of the flowchart of FIGS. 5-7 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 5 and/or 6 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may be implemented by external hardware circuitry. For example, the external hardware 1206 may be implemented by the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations that may correspond to at least some of the machine readable instructions of FIGS. 5 and/or 6 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowchart of FIGS. 5-7 may be executed by one or more of the cores 1102 of FIG. 11, a second portion of the machine readable instructions represented by the flowchart of FIGS. 5-7 may be executed by the FPGA circuitry 1200 of FIG. 12, and/or a third portion of the machine readable instructions represented by the flowchart of FIGS. 5-7 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

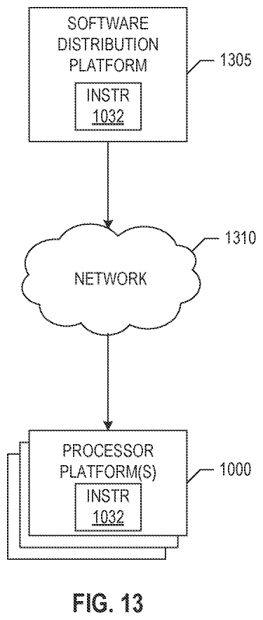

A block diagram illustrating an example software distribution platform 1305 to distribute software such as the example machine readable instructions 1032 of FIG. 10 to hardware devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions 500, 600, and 700 of FIGS. 5-7, as described above. The one or more servers of the example software distribution platform 1305 are in communication with an example network 1310, which may correspond to any one or more of the Internet and/or any of the example networks 130 and/or 238 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1305. For example, the software, which may correspond to the example machine readable instructions 500, 600, and 700 of FIGS. 5-7, may be downloaded to the example processor platform 1000, which is to execute the machine readable instructions 1032 to implement FIGS. 2-4. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

From the foregoing, it will be appreciated that example systems, methods, apparatus, and articles of manufacture have been disclosed that integrate smartNICs into traditional platform management. Disclosed systems, methods, apparatus, and articles of manufacture improve the efficiency of using a computing device by integrating smartNICs into traditional platform management. In general, traditional systems and methods do not provide the added performance advantages of integrating smartNICs with traditional platforms. Disclosed systems, methods, apparatus, and articles of manufacture allow smartNIC hardware to be monitored without adding additional hardware. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to integrate smartNICs into platform management systems are disclosed herein. Further examples and combinations thereof include the following:

Example 1 includes a system comprising memory, programmable circuitry, and instructions to program the programmable circuitry to determine a presence of a smart network interface card based on detection of a kernel-to-kernel network interface card, classify a request from a client application, the request to obtain sensor data, determine whether the request is to be sent to a server hardware baseboard management controller or the smart network interface card, based on the determination, cause sending of the request to the smart network interface card, the request to cause the smart network interface card to obtain the sensor data from a sensor corresponding to the smart network interface card, and access a response from the smart network interface card, the response indicative of at least one sensor data record corresponding to the sensor.

Example 2 includes the system of example 1, wherein the sensor is a first sensor, the programmable circuitry to replace a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

Example 3 includes the system of example 1, wherein the response is a first response, the programmable circuitry to combine the first response with a second response to generate an aggregate response.

Example 4 includes the system of example 1, wherein the programmable circuitry is to determine a status of the sensor based on the at least one sensor data record, and cause sending of the status of the sensor to the client application in response to the request.

Example 5 includes the system of example 1, wherein the sensor is a temperature sensor.

Example 6 includes the system of example 1, wherein the programmable circuitry is to determine, based on a resource map, that the sensor is associated with the smart network interface card.

Example 7 includes the system of example 1, wherein the sensor is a first sensor, the programmable circuitry to cause the sending of the request to the smart network interface card after determining, based on a resource map, that the sensor identified in the request corresponds to the smart network interface card.

Example 8 includes the system of example 1, wherein the smart network interface card does not include a baseboard management controller (BMC).

Example 9 includes at least one non-transitory computer readable medium comprising instructions to cause programmable circuitry to at least determine a presence of a smart network interface card based on detection of a kernel-to-kernel network interface card, classify a request from a client application, the request to obtain sensor data, determine whether the request is to be sent to a server hardware baseboard management controller or the smart network interface card, based on the determination, cause sending of the request to the smart network interface card, the request to cause the smart network interface card to obtain the sensor data from a sensor corresponding to the smart network interface card, and access a response from the smart network interface card, the response indicative of at least one sensor data record corresponding to the sensor.

Example 10 includes the at least one non-transitory computer readable medium of example 9, wherein the sensor is a first sensor, the programmable circuitry to replace a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

Example 11 includes the at least one non-transitory computer readable medium of example 9, wherein the response is a first response, the instructions to cause the programmable circuitry to combine the first response with a second response to generate an aggregate response.

Example 12 includes the at least one non-transitory computer readable medium of example 9, wherein the instructions are to cause the programmable circuitry to determine a status of the sensor based on the at least one sensor data record, and cause sending of the status of the sensor to the client application in response to the request.

Example 13 includes the at least one non-transitory computer readable medium of example 9, wherein the sensor is a temperature sensor.

Example 14 includes the at least one non-transitory computer readable medium of example 9, wherein the instructions are to cause the programmable circuitry to determine, based on a resource map, that the sensor is associated with the smart network interface card.

Example 15 includes the at least one non-transitory computer readable medium of example 9, wherein the sensor is a first sensor, the instructions to cause the sending of the request to the smart network interface card after determining, based on a resource map, that the sensor identified in the request corresponds to the smart network interface card.

Example 16 includes the at least one non-transitory computer readable medium of example 9, wherein the smart network interface card does not include a baseboard management controller (BMC).

Example 17 includes a method comprising determining, by executing an instruction with programmable circuitry, a presence of a smart network interface card based on detection of a kernel-to-kernel network interface card, classifying, by executing an instruction with the programmable circuitry, a request from a client application, the request to obtain sensor data, determining, by executing an instruction with the programmable circuitry, whether the request is to be sent to at least one of a server hardware baseboard management controller or the smart network interface card, based on the determination, causing sending of the request to the smart network interface card, the request to cause the smart network interface card to obtain the sensor data from a sensor corresponding to the smart network interface card, and accessing, by executing an instruction with the programmable circuitry, a response from the smart network interface card, the response indicative of at least one sensor data record corresponding to the sensor.

Example 18 includes the method of example 17, wherein the sensor is a first sensor, the method further including replacing a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

Example 19 includes the method of example 17, wherein the response is a first response, and further including combining the first response with a second response to generate an aggregate response.

Example 20 includes the method of example 17, further including determining a status of the sensor based on the at least one sensor data record, and causing sending of the status of the sensor to the client application in response to the request.

Example 21 includes the method of example 17, wherein the sensor is a temperature sensor.

Example 22 includes the method of example 17, further including determining, based on a resource map, that the sensor is associated with the smart network interface card.

Example 23 includes the method of example 17, wherein the sensor is a first sensor, the method further including causing the sending of the request to the smart network interface card after determining, based on a resource map, that the sensor identified in the request corresponds to the smart network interface card.

Example 24 includes the method of example 17, wherein the smart network interface card does not include a baseboard management controller (BMC).

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A system comprising:
memory;
programmable circuitry; and
instructions to program the programmable circuitry to:
determine a presence of a smart network interface card based on detection of a kernel-to-kernel network interface card;
classify a request from a client application, the request to obtain sensor data;
determine whether the request is to be sent to a server hardware baseboard management controller or the smart network interface card;
based on the determination, cause sending of the request to the smart network interface card, the request to cause the smart network interface card to obtain the sensor data from a sensor corresponding to the smart network interface card; and
access a response from the smart network interface card, the response indicative of at least one sensor data record corresponding to the sensor.

2. The system of claim 1, wherein the sensor is a first sensor, the programmable circuitry to replace a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

3. The system of claim 1, wherein the response is a first response, the programmable circuitry to combine the first response with a second response to generate an aggregate response.

4. The system of claim 1, wherein the programmable circuitry is to:
determine a status of the sensor based on the at least one sensor data record; and
cause sending of the status of the sensor to the client application in response to the request.

5. The system of claim 1, wherein the sensor is a temperature sensor.

6. The system of claim 1, wherein the programmable circuitry is to determine, based on a resource map, that the sensor is associated with the smart network interface card.

7. The system of claim 1, wherein the sensor is a first sensor, the programmable circuitry to cause the sending of the request to the smart network interface card after determining, based on a resource map, that the sensor identified in the request corresponds to the smart network interface card.

8. The system of claim 1, wherein the smart network interface card does not include a baseboard management controller (BMC).

9. At least one non-transitory computer readable medium comprising instructions to cause programmable circuitry to at least:
determine a presence of a smart network interface card based on detection of a kernel-to-kernel network interface card;
classify a request from a client application, the request to obtain sensor data;
determine whether the request is to be sent to a server hardware baseboard management controller or the smart network interface card;
based on the determination, cause sending of the request to the smart network interface card, the request to cause the smart network interface card to obtain the sensor data from a sensor corresponding to the smart network interface card; and
access a response from the smart network interface card, the response indicative of at least one sensor data record corresponding to the sensor.

10. The at least one non-transitory computer readable medium of claim 9, wherein the sensor is a first sensor, the programmable circuitry to replace a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

11. The at least one non-transitory computer readable medium of claim 9, wherein the response is a first response, the instructions to cause the programmable circuitry to combine the first response with a second response to generate an aggregate response.

12. The at least one non-transitory computer readable medium of claim 9, wherein the instructions are to cause the programmable circuitry to:
determine a status of the sensor based on the at least one sensor data record; and
cause sending of the status of the sensor to the client application in response to the request.

13. The at least one non-transitory computer readable medium of claim 9, wherein the sensor is a temperature sensor.

14. The at least one non-transitory computer readable medium of claim 9, wherein the instructions are to cause the programmable circuitry to determine, based on a resource map, that the sensor is associated with the smart network interface card.

15. The at least one non-transitory computer readable medium of claim 9, wherein the sensor is a first sensor, the instructions to cause the sending of the request to the smart network interface card after determining, based on a resource map, that the sensor identified in the request corresponds to the smart network interface card.

16. The at least one non-transitory computer readable medium of claim 9, wherein the smart network interface card does not include a baseboard management controller (BMC).

17. A method comprising:
determining, by executing an instruction with programmable circuitry, a presence of a smart network interface card based on detection of a kernel-to-kernel network interface card;
classifying, by executing an instruction with the programmable circuitry, a request from a client application, the request to obtain sensor data;
determining, by executing an instruction with the programmable circuitry, whether the request is to be sent to at least one of a server hardware baseboard management controller or the smart network interface card;
based on the determination, causing sending of the request to the smart network interface card, the request to cause the smart network interface card to obtain the sensor data from a sensor corresponding to the smart network interface card; and
accessing, by executing an instruction with the programmable circuitry, a response from the smart network interface card, the response indicative of at least one sensor data record corresponding to the sensor.

18. The method of claim 17, wherein the sensor is a first sensor, the method further including replacing a first identifier with a second identifier based on a resource map, the first identifier used by the smart network interface card to identify the sensor, the replacing of the first identifier with the second identifier to distinguish the first sensor corresponding to the smart network interface card from a second sensor corresponding to the server hardware baseboard management controller.

19. The method of claim 17, wherein the response is a first response, and further including combining the first response with a second response to generate an aggregate response.

20. The method of claim 17, further including:
determining a status of the sensor based on the at least one sensor data record; and
causing sending of the status of the sensor to the client application in response to the request.

21. The method of claim 17, wherein the sensor is a temperature sensor.

22. The method of claim 17, further including determining, based on a resource map, that the sensor is associated with the smart network interface card.

23. The method of claim 17, wherein the sensor is a first sensor, the method further including causing the sending of the request to the smart network interface card after determining, based on a resource map, that the sensor identified in the request corresponds to the smart network interface card.

24. The method of claim 17, wherein the smart network interface card does not include a baseboard management controller (BMC).
